(19) United States
(12) Patent Application Publication
(10) Pub. No.: US 2019/0275634 A1
(43) Pub. Date: Sep. 12, 2019

(54) SYSTEMS AND METHODS FOR BUFFERING ROBOTIC TOOL ATTACHMENTS

(71) Applicants: Chad Ashley White, Richmond, CA (US); Dawn Felicity White, Richmond, CA (US)

(72) Inventors: Chad Ashley White, Richmond, CA (US); Dawn Felicity White, Richmond, CA (US)

(21) Appl. No.: 16/295,339

(22) Filed: Mar. 7, 2019

Related U.S. Application Data
(60) Provisional application No. 62/641,264, filed on Mar. 9, 2018.

(51) Int. Cl. B24B 41/06; B25J 9/00; F16F 1/12; B24B 21/00

(52) U.S. Cl. CPC B24B 41/06; B24B 21/00; F16F 1/12; B25J 9/0009

(57) ABSTRACT

An improved robotic tool buffering system flexibly suspends a finishing tool from a robotic arm while providing substantially constant compression pressure using use. The buffering system includes a robotic arm interface attached to a robotic arm, a finishing tool interface attached to a surface finishing tool, and a plurality of compressible mechanical buffer assemblies. The buffer assemblies provide substantially constant compression pressure between the finishing tool and a target surface, and also provide a substantially level orientation of the finishing tool relative to the target surface. Each buffer assembly includes a coupler, a hollow compressible buffer and an axial stop.

### CROSS REFERENCE TO RELATED APPLICATION

This non-provisional application claims the benefit of U.S. provisional application No. 62/641,264 entitled “Systems and Methods for Buffering Robotic Tool Attachments,” Attorney Docket No. PRF-1801-P, filed in the USPTO on Mar. 9, 2018, by inventors Chad White et. al., which is incorporated herein by reference.

### BACKGROUND

The present invention relates to buffering systems and methods for cost-effectively and flexibly attaching finishing tools such as sanders and polishers to robotic arms.

Current commercially available robotic arm buffering systems tend to be expensive to purchase and maintain, primarily because many of them rely on complex real-time feedback loops to provide constant compression pressure between the finishing tool and the robotic arm during use. Examples of complex feedback loops include cameras with image recognition and/or actively-controlled hydraulic buffering systems.

It is therefore apparent that an urgent need exists for lower-cost buffering systems between robotic arms and finishing tools. These improved buffering systems offer substantially constant compression pressure without the high costs associated with complex real-time feedback systems.

### SUMMARY

To achieve the foregoing and in accordance with the present invention, systems and methods for securely and flexibly attaching finishing tools to robotic arms are provided.

In one embodiment, a robotic tool buffering system flexibly suspends a finishing tool from a robotic arm while providing substantially constant compression pressure using use. The buffering system includes a robotic arm interface attached to a robotic arm, a finishing tool interface attached to a surface finishing tool, and a plurality of compressible mechanical non-hydraulic buffer assemblies.

The buffer assemblies couple the robotic arm interface to the tool interface. The buffer assemblies provide substantially constant compression pressure between the finishing tool and a target surface, and also provide a substantially level orientation of the finishing tool relative to the target surface, during the finishing process. Each buffer assembly includes a coupler, one or more hollow compressible buffer and an axial stop. The coupler is secured to the robotic arm interface while permitting the tool interface to travel along a radial axis of the coupler relative to the robotic arm interface. The axial travel stop flexibly secures the tool interface to the robotic arm interface while preventing separation of the finishing tool from the robotic arm during use.

In some embodiments, the coupler is welded or brazed to the robotic arm interface. The coupler can be a threaded bolt while the axial travel stop can be a locknut. The hollow compressible buffer can be a helical spring.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIGS. 1 and 2A-2B depict perspective view and side view, respectively, of one embodiment of a robotic tool buffering system attached to a finishing tool in accordance with the present invention;

FIGS. 3A-3B are cross-section views of a buffer assembly for the robotic tool buffering system of FIG. 1;

FIG. 3C is a side view of an exemplary hollow buffer, a helical spring, for buffer assembly of FIG. 3A.

FIG. 4 depicts a welded/brazed coupler for the buffer assembly of FIG. 3A;

FIG. 5 depicts another embodiment of a buffer assembly having an additional locknut for the robotic tool buffering system of FIG. 1;

FIGS. 6A-6H, 7A-7F and 8 illustrate alternate embodiments of couplers and travel stops for the robotic tool buffering system of FIG. 1;

FIGS. 9A-9C and 10A-10B depict two additional embodiments of buffer assemblies for the robotic tool buffering system of FIG. 1; and

FIGS. 11A-11F illustrates additional embodiments of hollow buffers for the buffer assembly of FIG. 3A.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “always,” “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

In addition, as used in this specification and the appended claims, the singular article forms “a,” “an,” and “the” include both singular and plural referents unless the context of their usage clearly dictates otherwise. Thus, for example, reference to “a retainer” includes a plurality of retainers as well as a single retainer, and the like.

The present invention relates to systems and methods for an improved robotic tool buffering system that provides flexible attachments for robotic arm tools such as sanders and polishers.

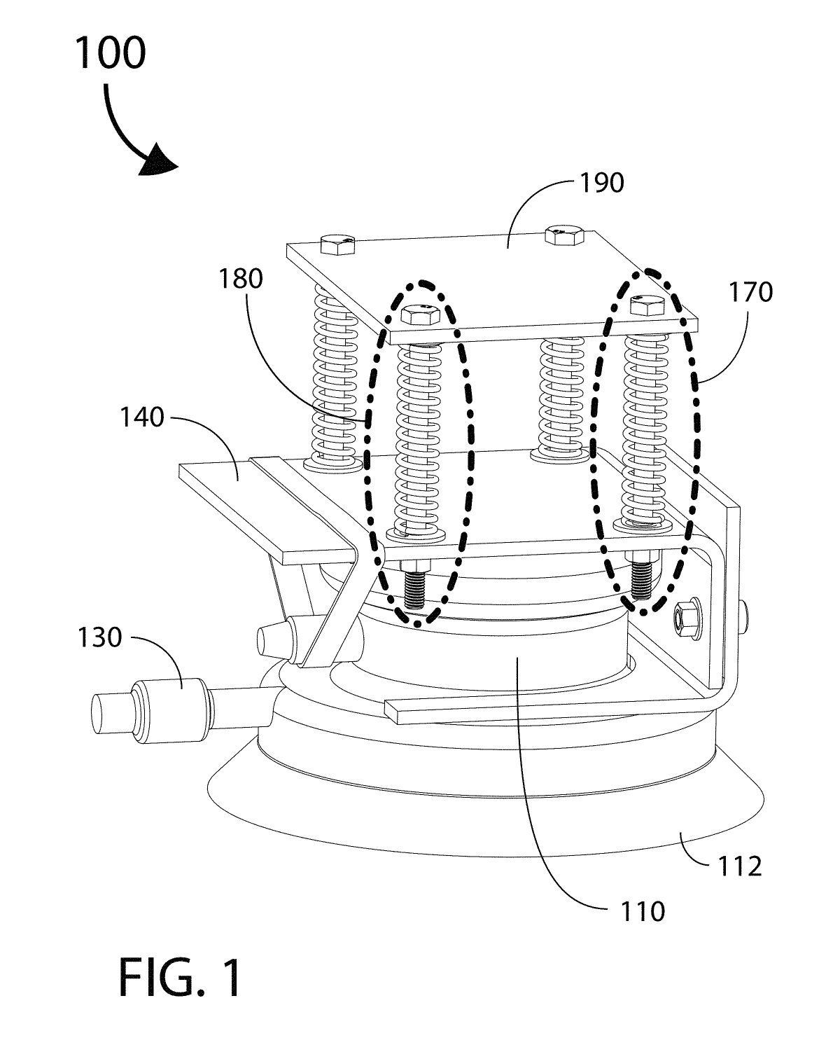

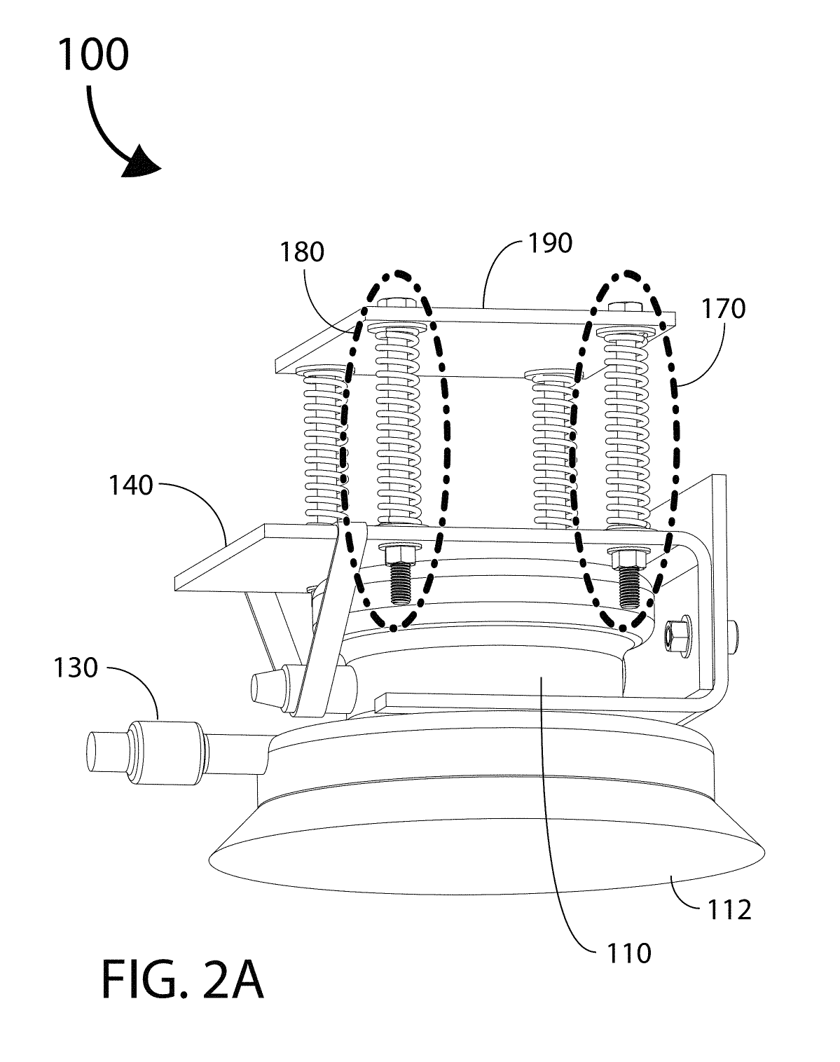

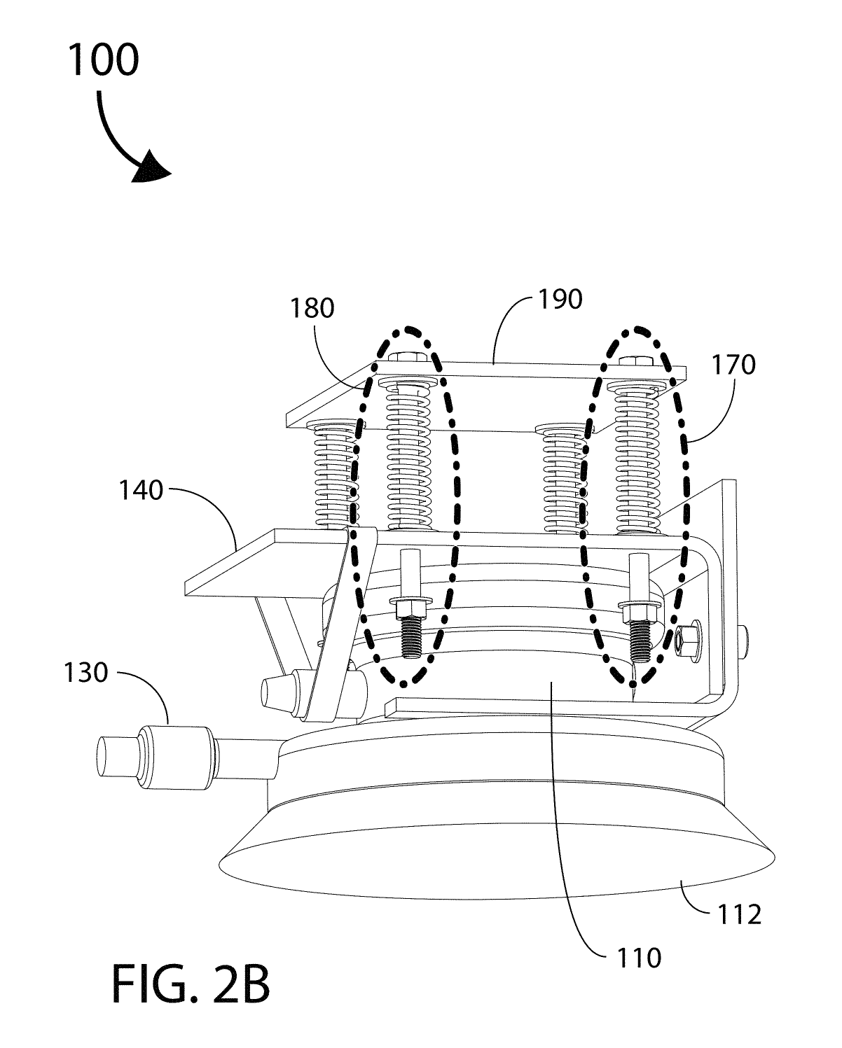

To facilitate discussion, FIGS. 1 and 2A-2B are perspective and side views illustrating one embodiment of a robotic tool buffering system 100 in accordance with the present invention. Buffering system 100 includes a robotic arm interface 190, a tool interface 140 and a plurality of buffer assemblies 170 . . . 180. The robotic arm interface 190 is intended to be attached to a robotic arm (not shown). A surface finishing tool 110, for example a sander, can be suspended from tool interface 140, to demonstrate intended use. Robotic arm interface 190 and tool interface 140 can be made from a variety of suitable materials, such as steel plate, aluminum plate, castings, carbon fiber, fiberglass, plastics, and composites, or combinations thereof.

As shown in the prototype of FIG. 1, finishing tool 110 can be a random-orbit palm sander with an abrasive/polishing pad 112 and an optional vacuum attachment 130. In order to substantially even pressure on a targeted surface being sanded (not shown), as an experienced human craftsman would, the buffering system 100 is coupled to the robotic arm (not shown) via the plurality of buffer assemblies 170 . . . 180. Accordingly, buffering system 100 provides springy “give” thereby simulating the even pressure provided by the experienced human craftsman (not shown), as the robotic arm guides the sander across the surface.

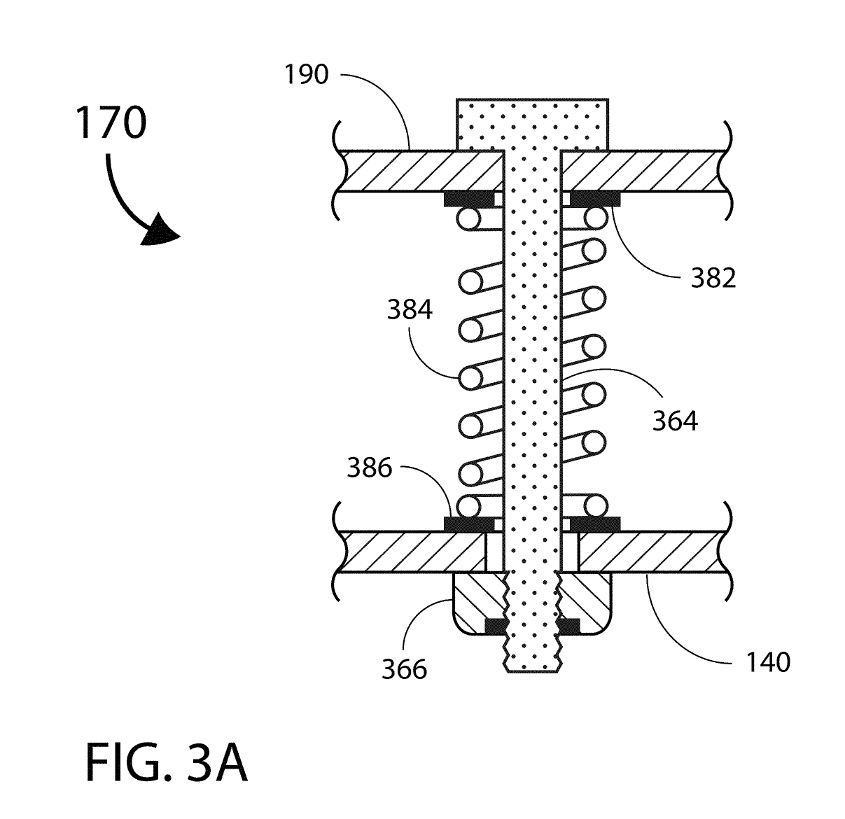

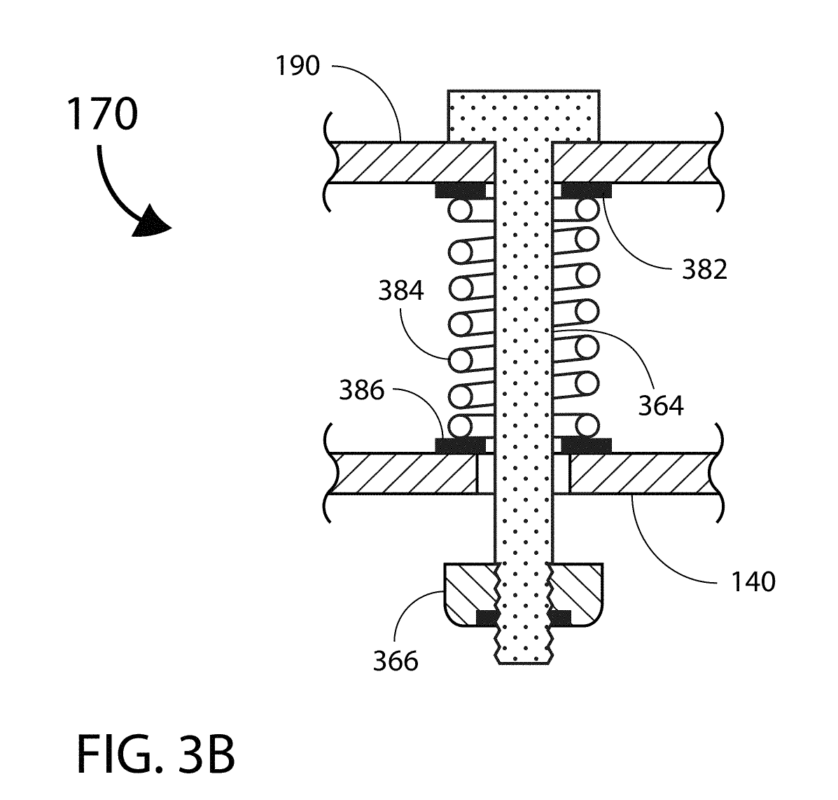

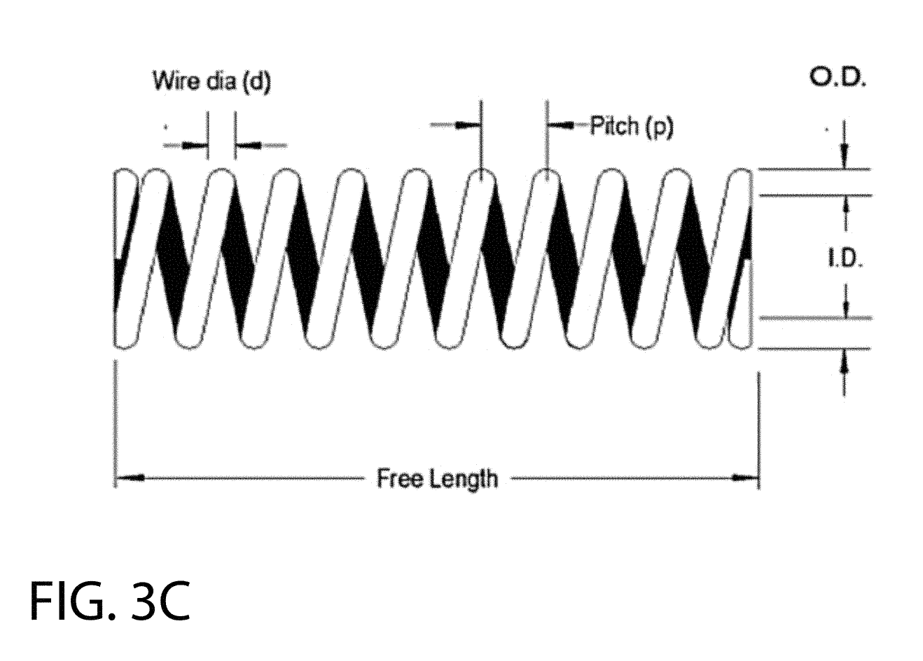

FIGS. 3A and 3B, corresponding to FIGS. 2A and 2B, are assembled and compressed cross-sectional views, respectively, of exemplary buffer assembly 170 which includes a fastener 364, a first washer 382, a compressible hollow buffer 384, a second washer 386 and a locknut 366. The locknut 366 flexibly secures buffer 384 sandwiched between robotic arm interface 190 and tool interface 140.

Suitable compressible materials for constructing exemplary mechanical buffering assembly 170 include helical spring 384 and threaded hex bolt 364 as shown in FIG. 3A. FIG. 3C is a side view of one such helical spring and depicts exemplary dimensions. In this embodiment, wire diameter is approximately 0.03″, pitch is approximately 0.22″, outer diameter (O.D.) is approximately 0.44″, inner diameter (I.D.) is approximately 0.36″ and free length is approximately 2″. When assembled, as depicted by FIG. 3A, the compressed length of spring 384 is approximately 1.5″. Commercially available helical springs include Part Number C-738, a 0.5″ (O.D.)×3″ (free length)×0.047″ (wire diameter) spring, distributed by Century Springs Corp. of 5959 Triumph Street, Commerce, Calif. 90040 A discussion of compressive forces is provided in Appendix A.

During use as illustrated by FIG. 3B, the robotic arm can be programmed to maintain substantially constant pressure on the targeted surface by compressing the plurality of mechanical buffer assemblies 170 . . . 180, while guiding the surface finishing tool 110 along a zigzag path intended to evenly sand/polish the targeted surface. As a result, the tool buffering system 100 is capable of mimicking the sanding motions of the experienced human craftsman. Note that the compressed in-use length of spring 384 averages about 1″ during sanding.

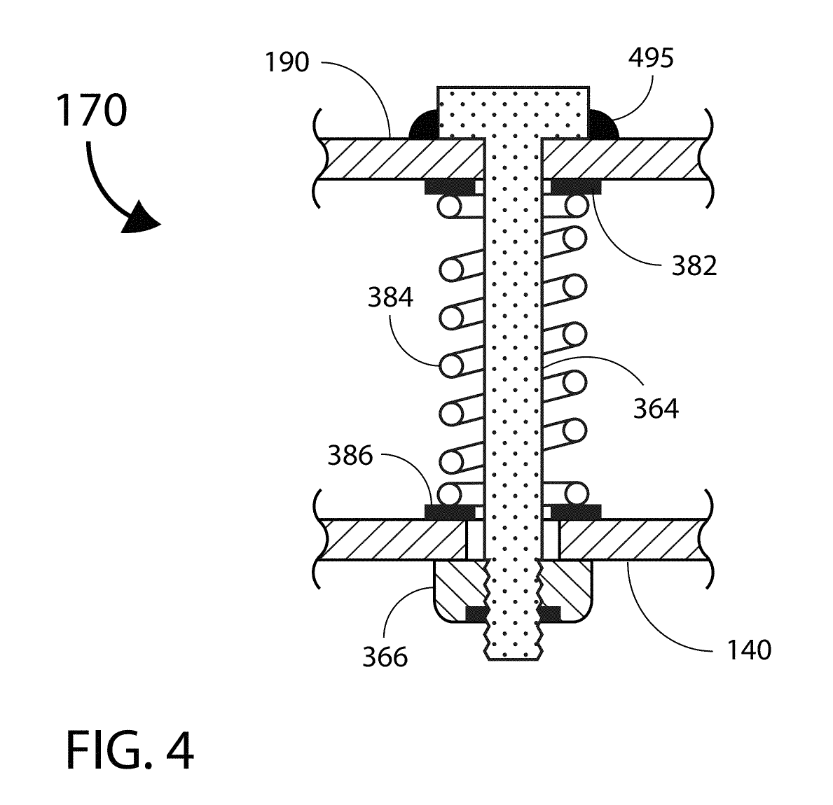

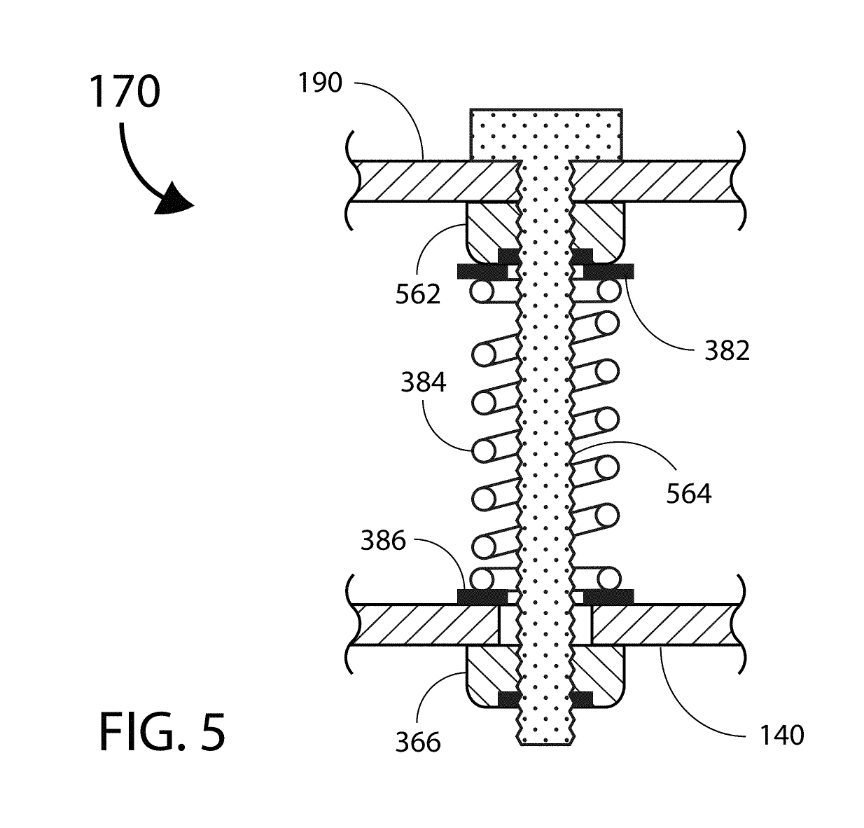

In this exemplary embodiment, fastener364 can be secured to robotic arm interface 190 by welding or brazing (see bead 495 of FIG. 4), or by an additional locknut 562 as shown in FIG. 5. Other suitable means for securing fastener 364 to robotic arm interface140 includes adhesives such as epoxies and screw threads with thread-locker, press fittings such as end caps, cotter pins, split pins, rivet nuts, threaded nut inserts, split rings, alone or in combination.

Depending on the specific implementation, finishing tool 110 can be temporality or permanently secured to the tool interface 140 using suitable structures such as custom mounts, screws, zip ties (see FIGS. 1 & 2), hook & loop fasteners, magnets, brackets, twist locks, ball detents and latches, alone or in combination.

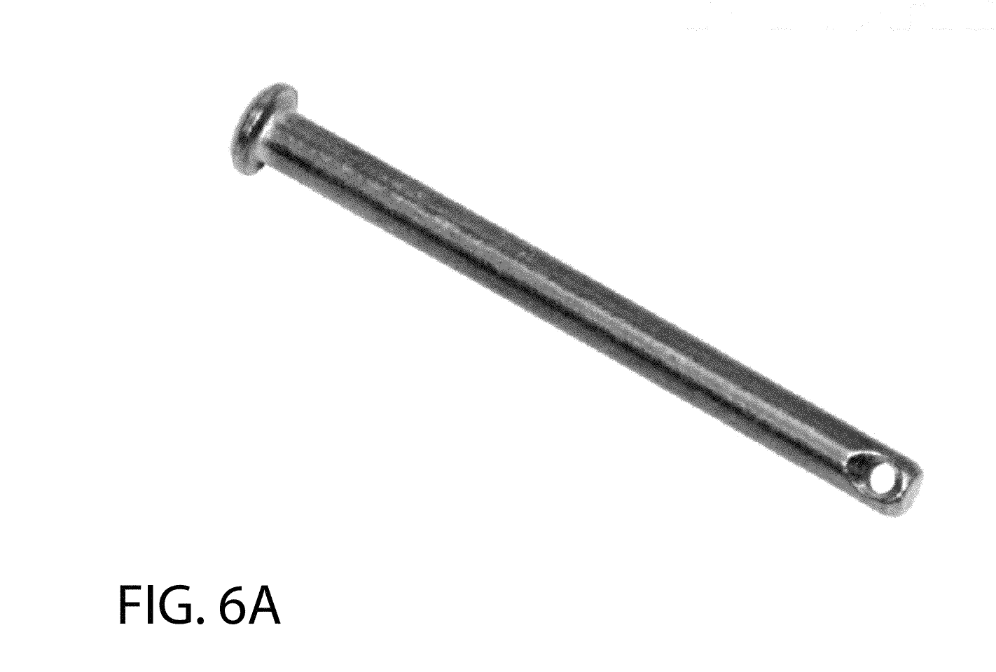

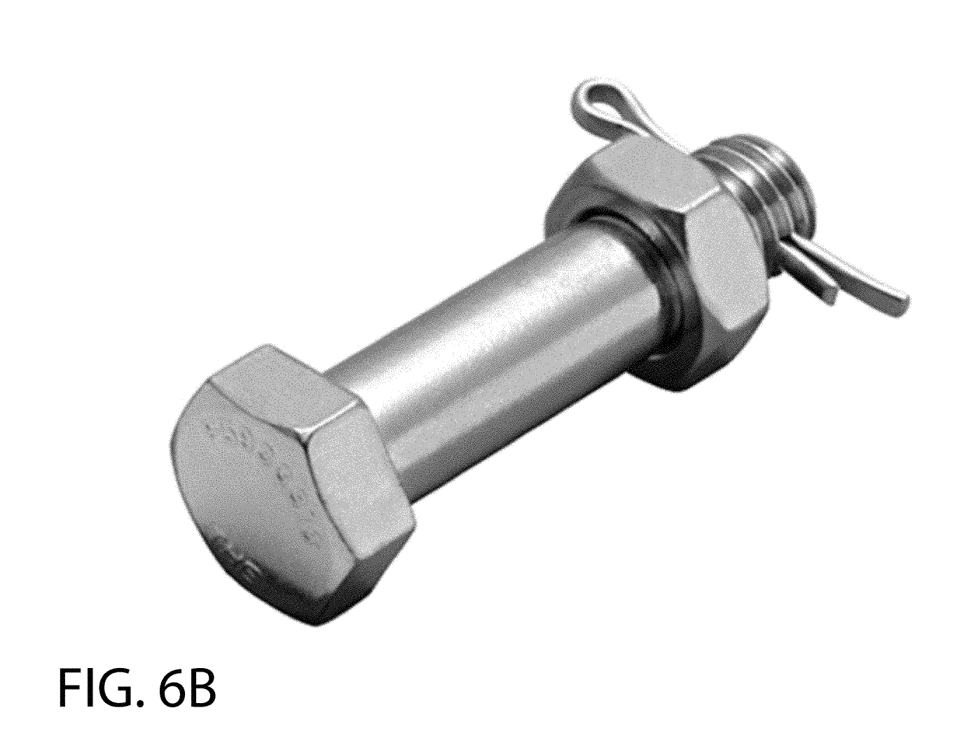

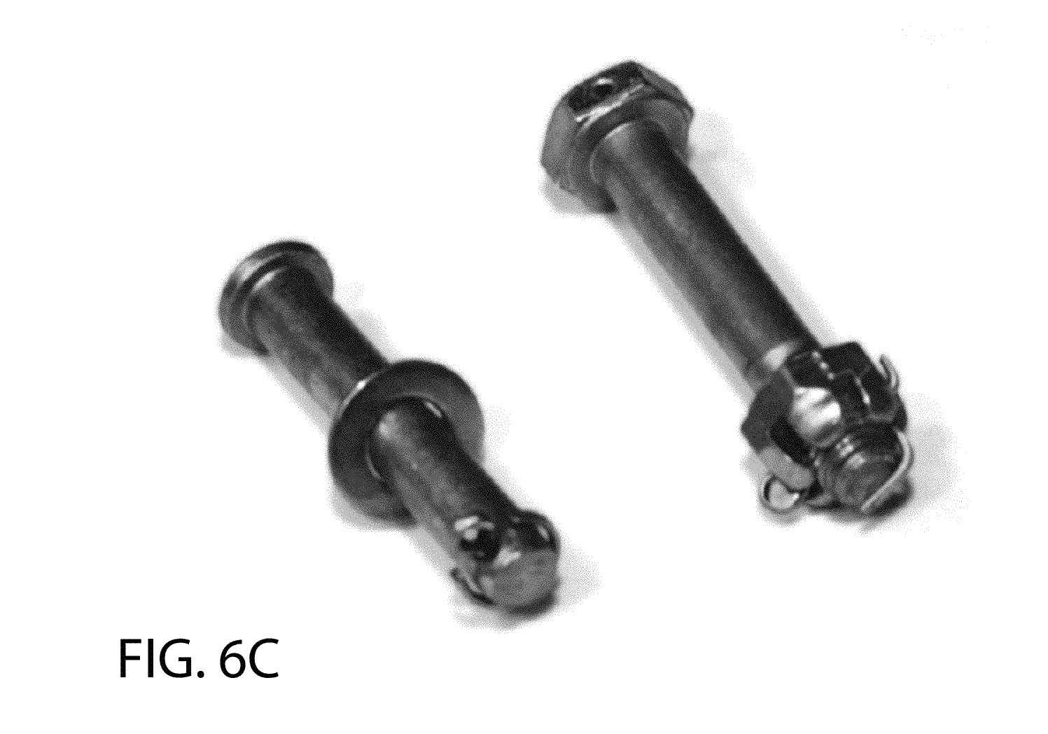

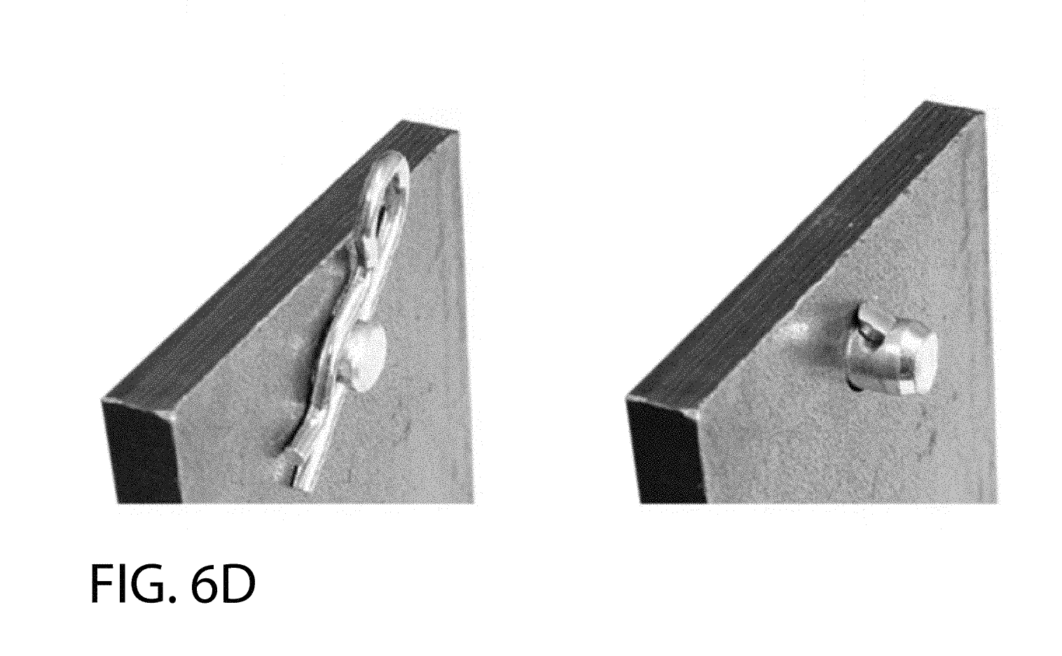

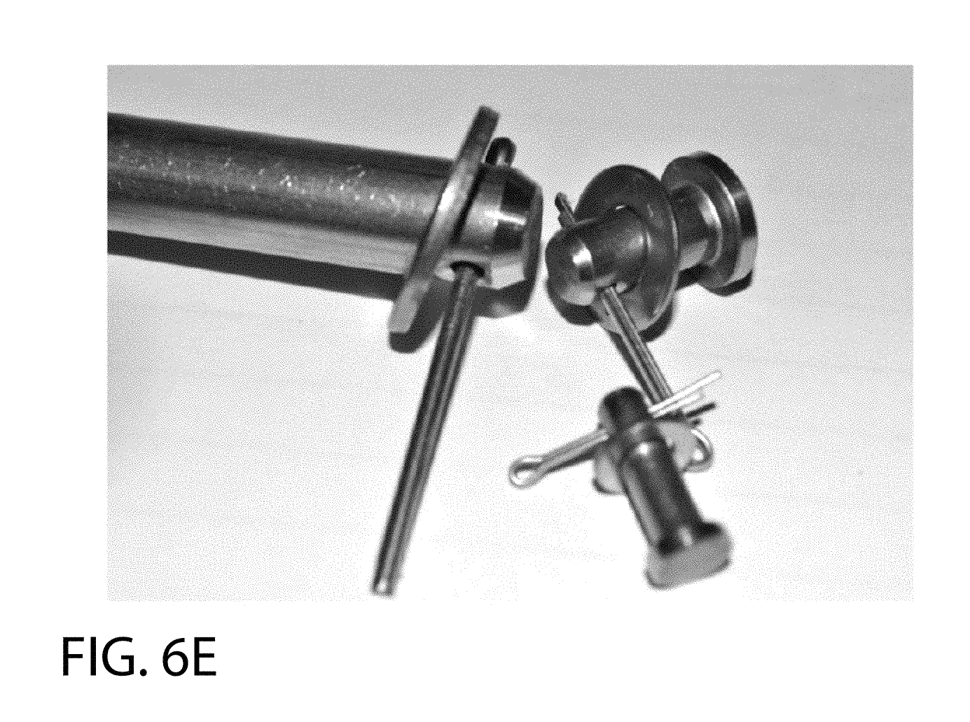

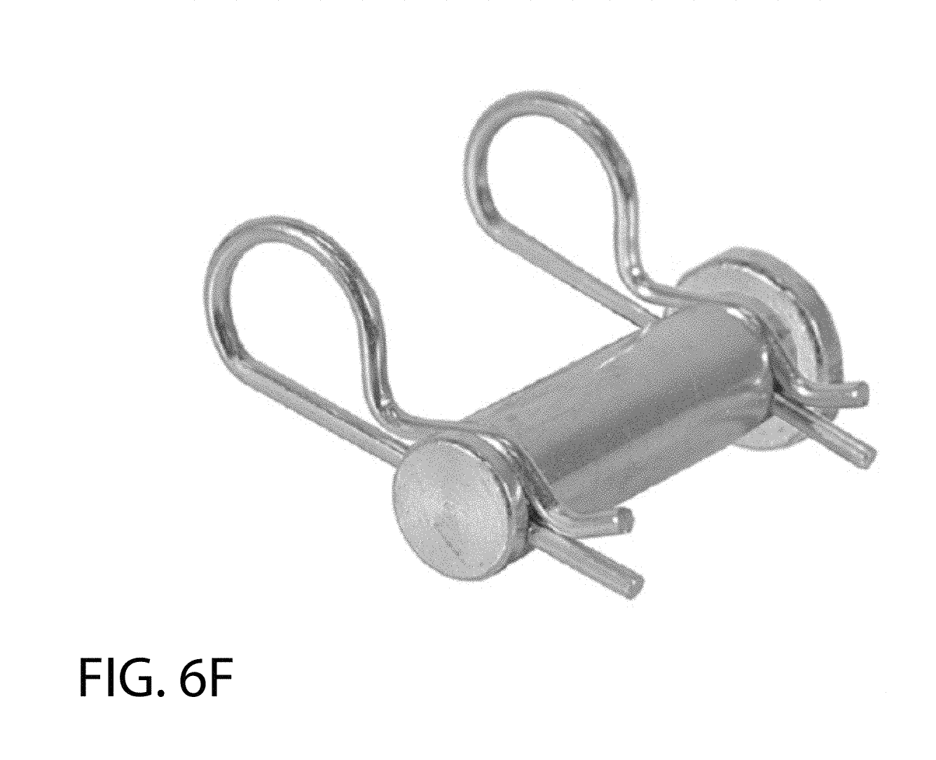

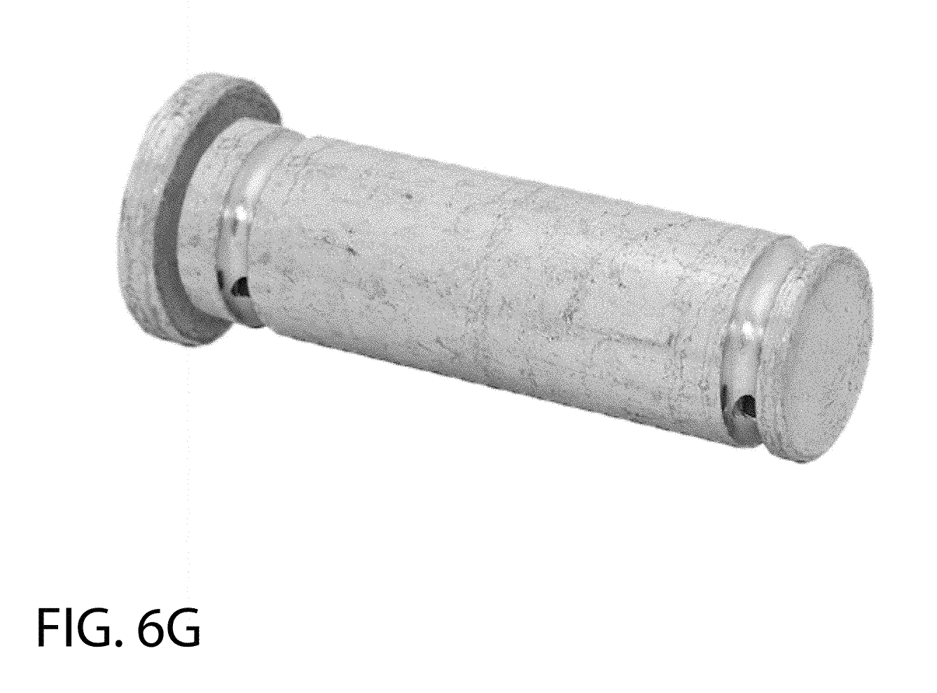

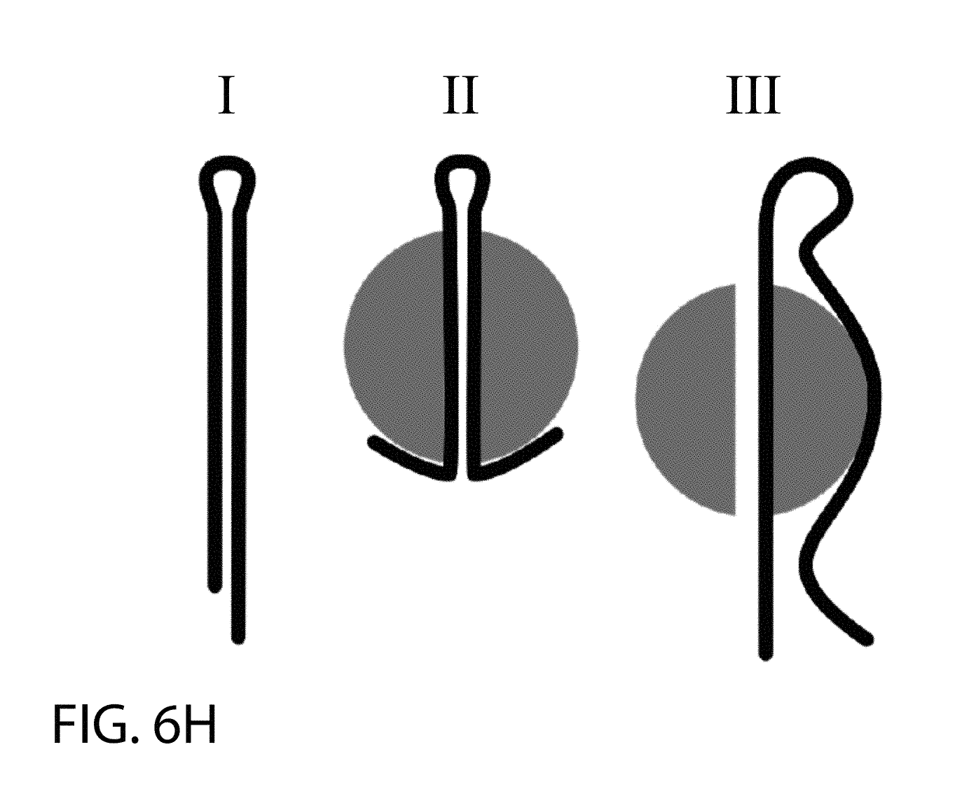

In some embodiments, locknut 366 can be supplemented with or substituted by a cotter pin. For example, FIGS. 6A-6H, 7A-7F and 8 illustrate alternate couplers and travel stops for the robotic tool buffering system 100. FIG. 6A depicts a coupler with a traverse through hole for accepting a pin, such as a cotter pin, or a split pin, while FIG. 6B depicts a threaded bolt with a threaded nut and a cotter pin. FIG. 6C shows two couplers, one with a washer and the other with a nut secured with cotter pin. In FIG. 6D, the plates are secured with exemplary traverse pins functioning as travel stops. FIG. 6E depicts additional examples of couplers with washers and cotter pins.

Referring now to FIGS. 6F-6G, the depicted coupler includes a pair of through holes aligned with a corresponding pair of circular groves for the pair of traversing pins suitable for securing tool interface 140 to robotic arm interface 190. FIG. 6H are cross-sectional views of exemplary coupler with cotter pins.

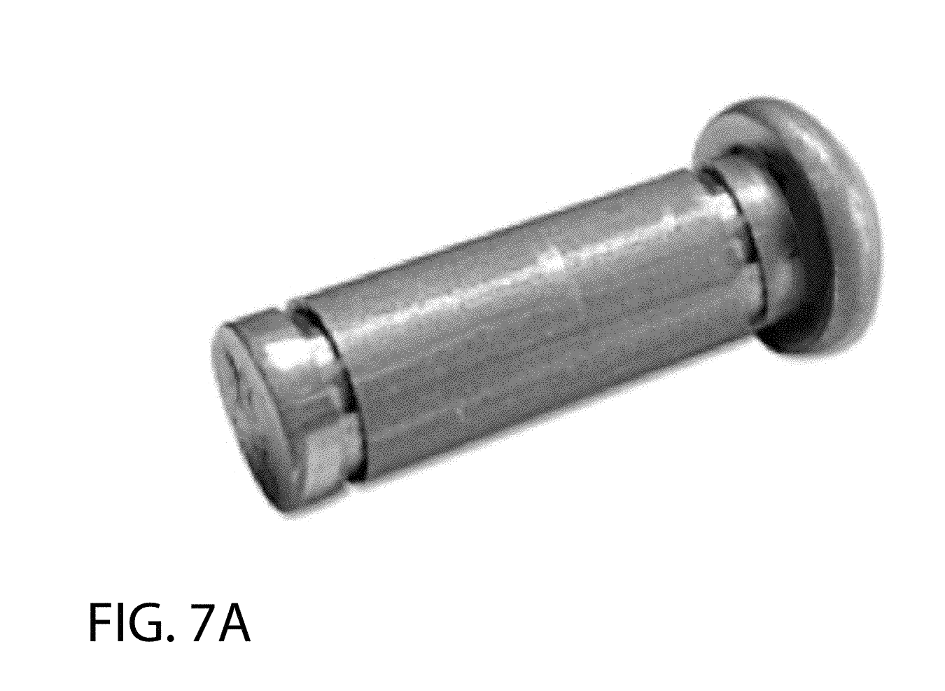

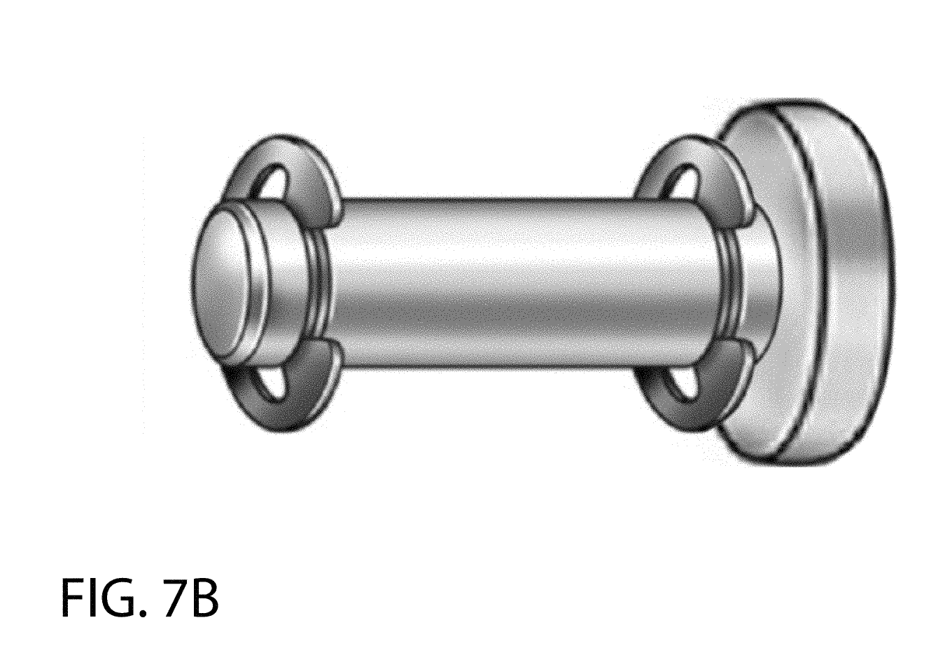

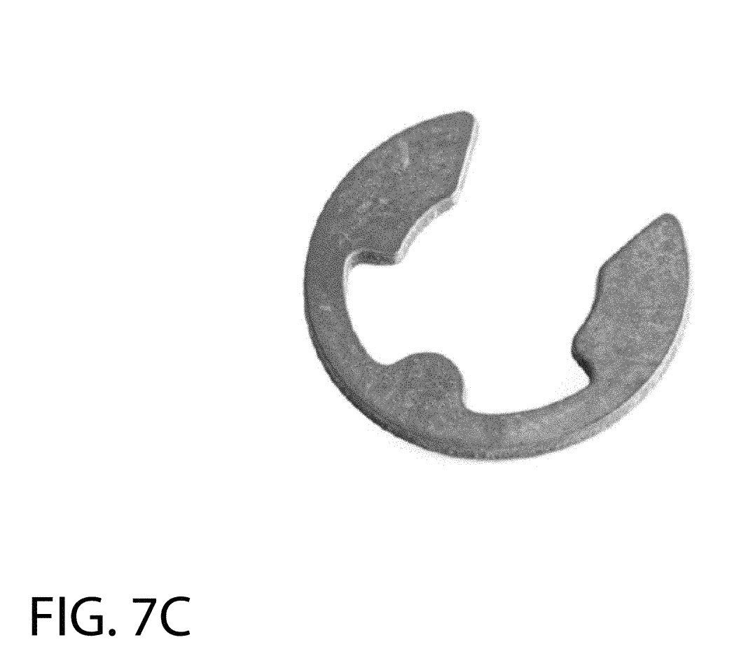

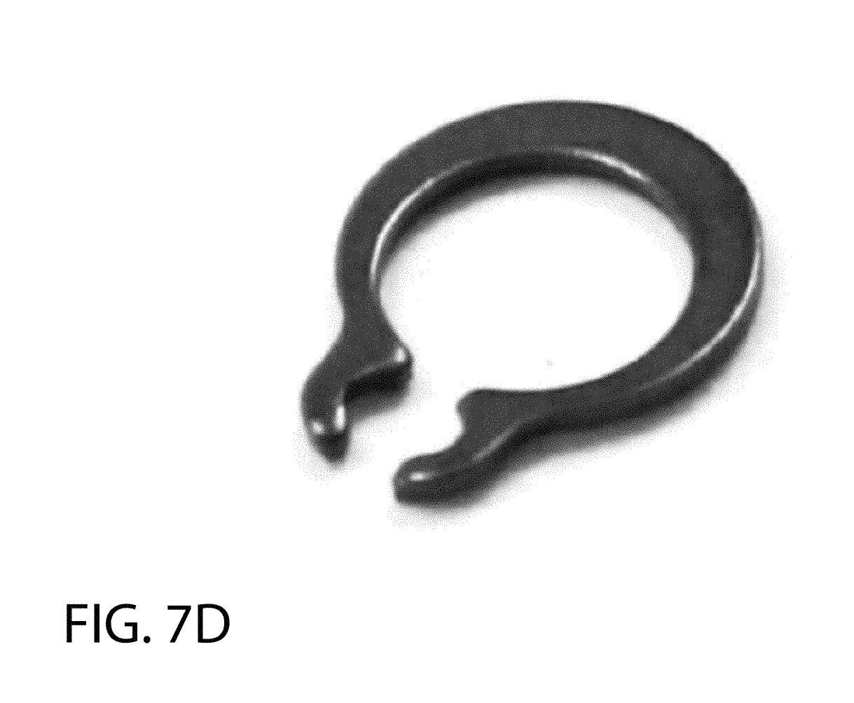

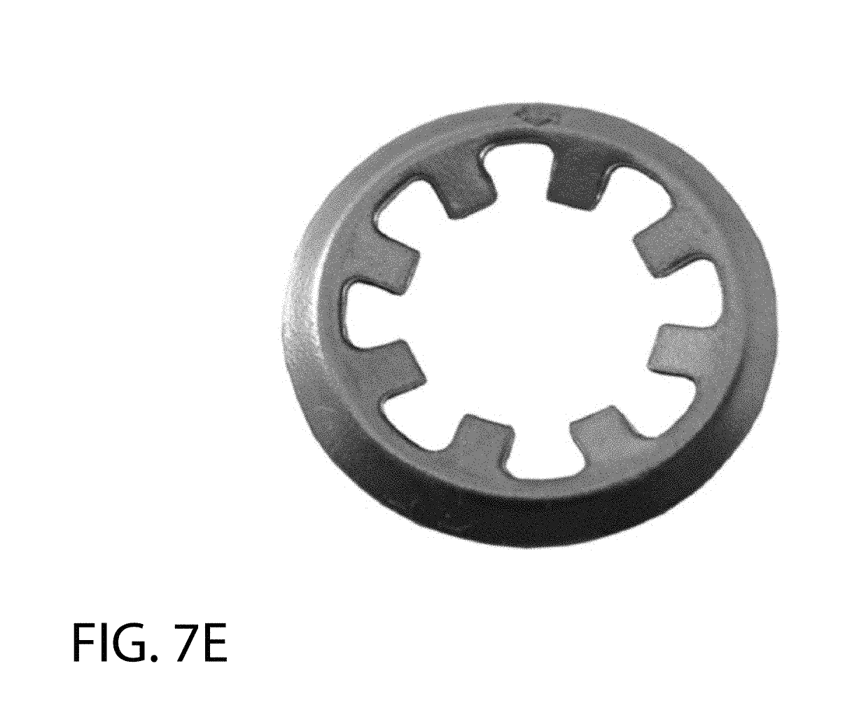

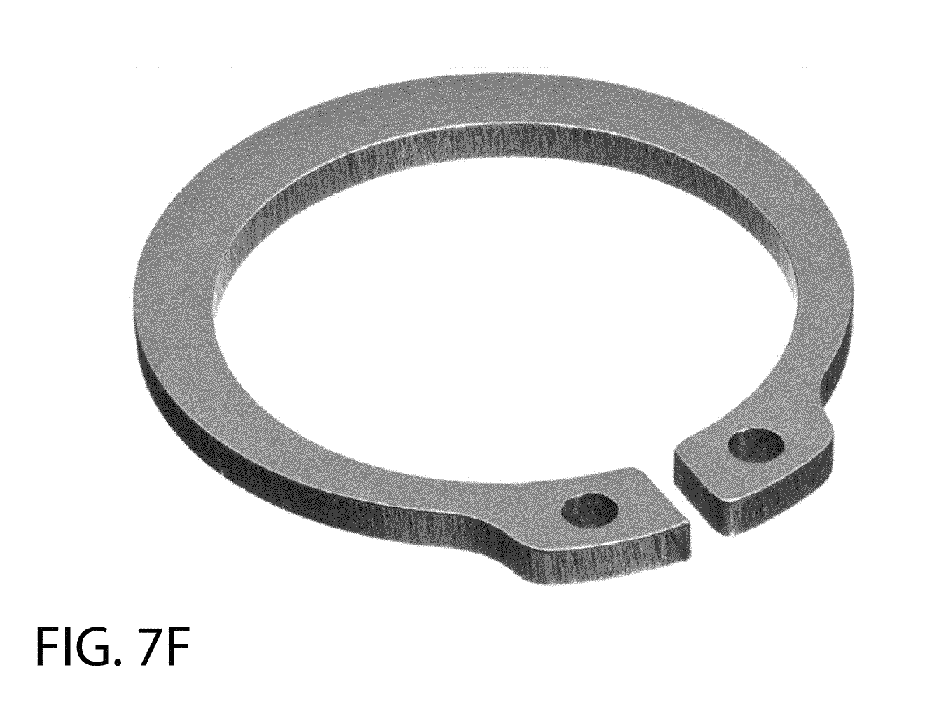

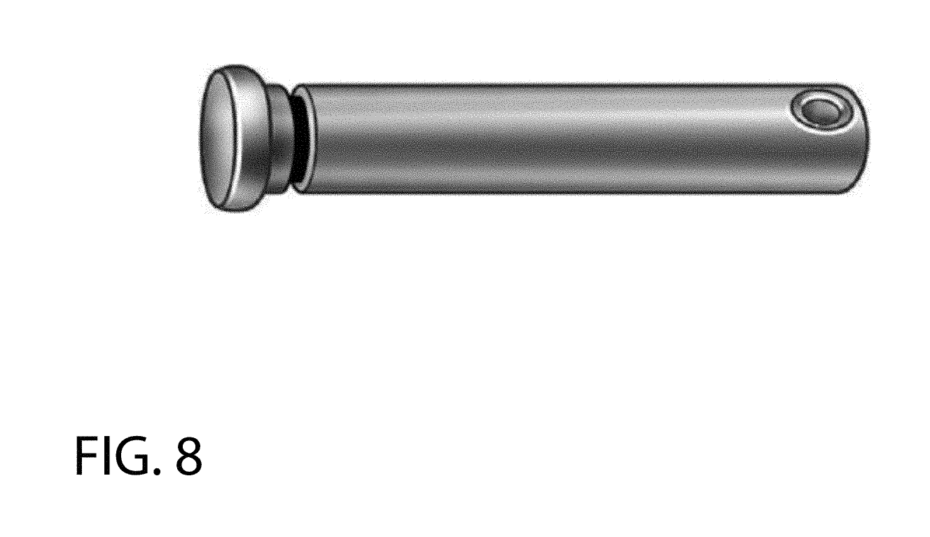

In FIGS. 7A-7B, the coupler includes a pair of circular channels configured for a corresponding pair of locking rings. Exemplary locking rings, including split rings, are shown in FIGS. 7C-7F. Note that nuts, locking rings and pins described above can be used alone or in combination, as exemplified by FIG. 8 showing a hybrid coupler with a circular channel and a separate traverse hole.

In some embodiments, one or more the buffer assemblies, include two or more inline springs having different compression indexes. These springs can be stacked or overlapped with respect to each other. These springs can also be side-by-side. Advantages of such structures include the ability to provide compression at substantially distinct pressure ranges. For example, a substantially higher compression range is useful for aggressive abrasive surface finishing of hard material such as mild steel, while a lower compression range is useful for finishing a softer material such as aluminum/plastic or for polishing/buffing.

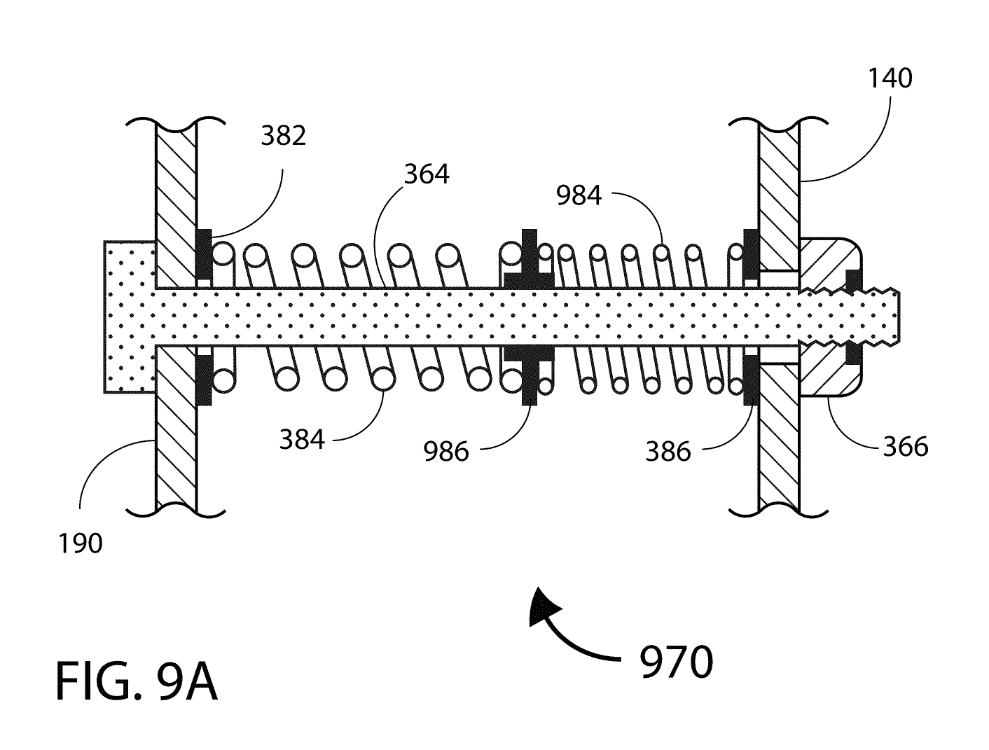

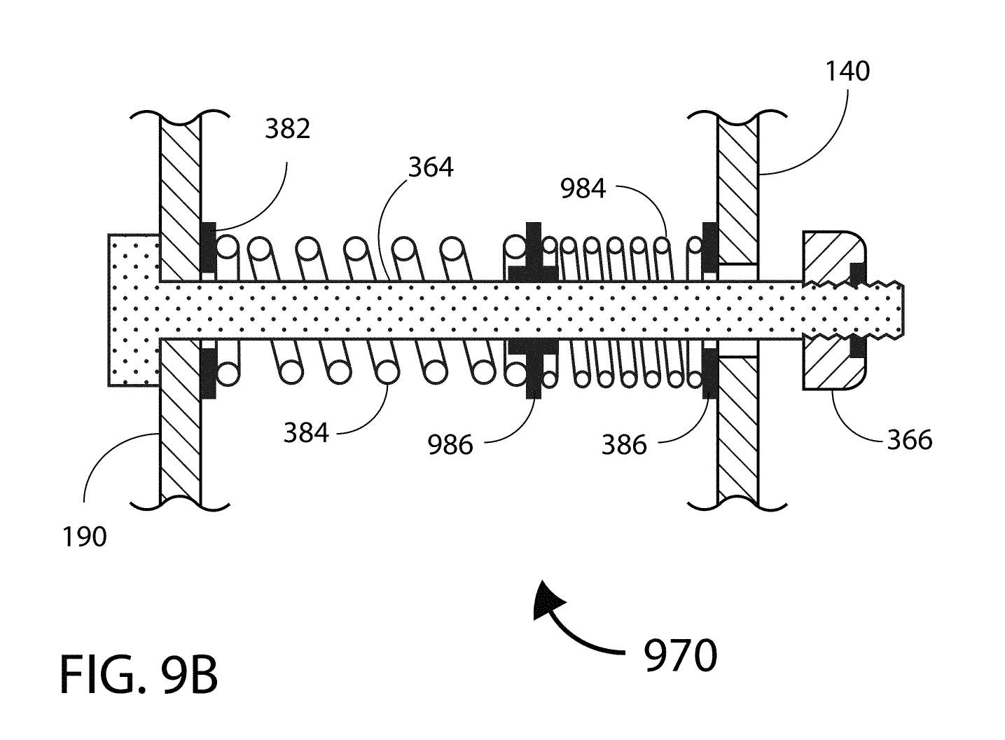

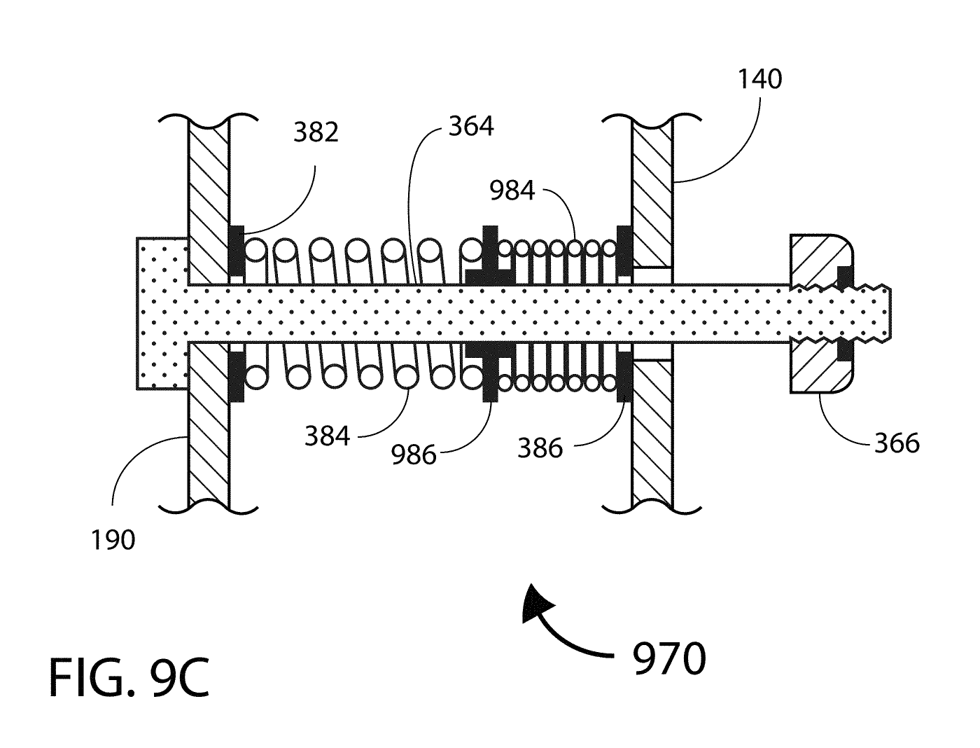

FIGS. 9A-9C illustrates one such alternate embodiment of a buffer assembly 970, utilizing inline dual springs 384 and 984, capable of providing two distinct compression pressure ranges for tool buffering system 100, thereby substantially increases utility. Buffer assembly 970 includes stabilizing collar 986 located between the springs 384, 984. The collar 986 is configured to travel freely with minimal friction along an axis of coupler 364, thereby enabling both springs 384, 984 to compress freely along the axis of coupler 364. Collar 986 can be made from a suitable self-lubricating material such as nylon or high-density polyethylene (HDPE). Alternatively, collar 986 and/or coupler 364 may be coated with a lubricating coating such as Teflon (polytetrafluoroethylene also known as PTFE).

In other words, the initial lower compression pressure range provided by softer spring 984 may be useful for gently polishing the target surface, e.g., with a buffing pad (see FIG. 9B). Referring to FIG. 9C, when an increased compression pressure is exerted by the robotic arm on the robotic interface 190, the softer spring 984 is compressed fully, and the stiffer spring 364 provides the higher compression pressure range ideal for sanding the target surface.

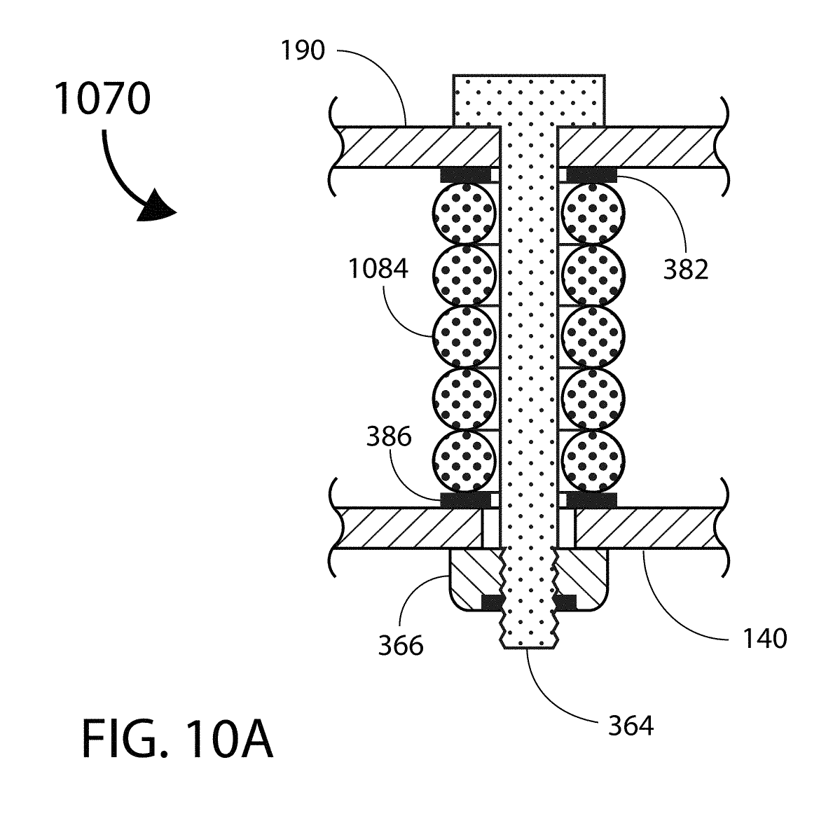

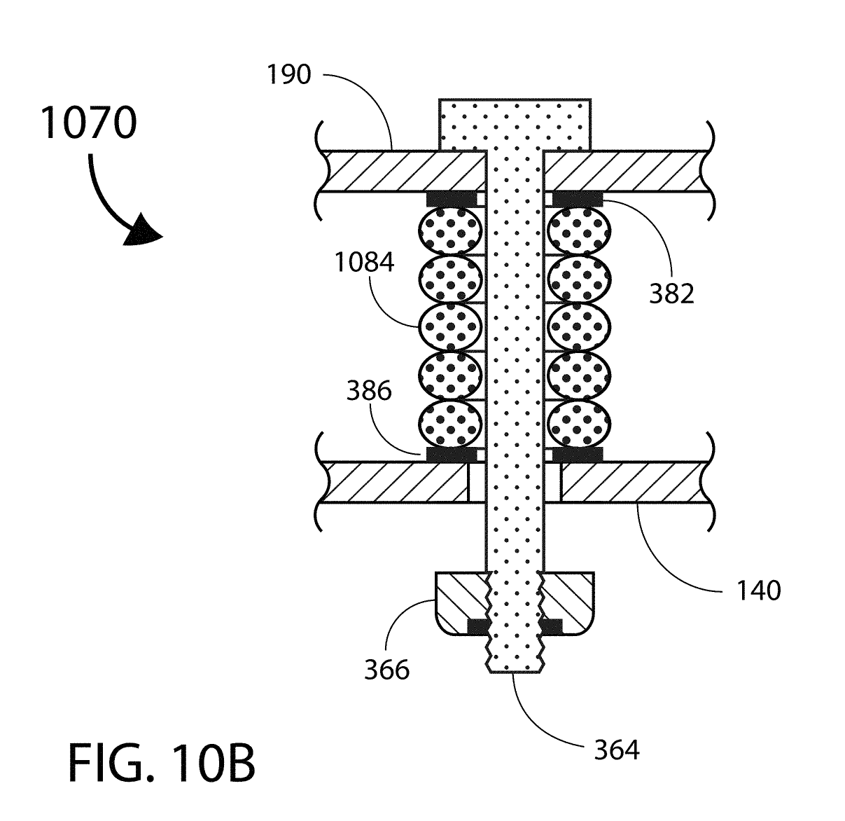

Many modifications and additions are also possible. For example, instead of helical springs from the embodiments illustrated by FIGS. 1-5 and 9A-9C, buffering assembly 1070 may use one or more solid compressible cylindrical and/or doughnut-shaped rings (see rings 1084 of FIGS. 10A-10B showing pre-compression and post-compression during use, respectively). Suitable compressible material such as natural or synthetic rubber, neoprene, vinyl, or silicone. It may also be possible to use helical springs in combination with solid compressible rings.

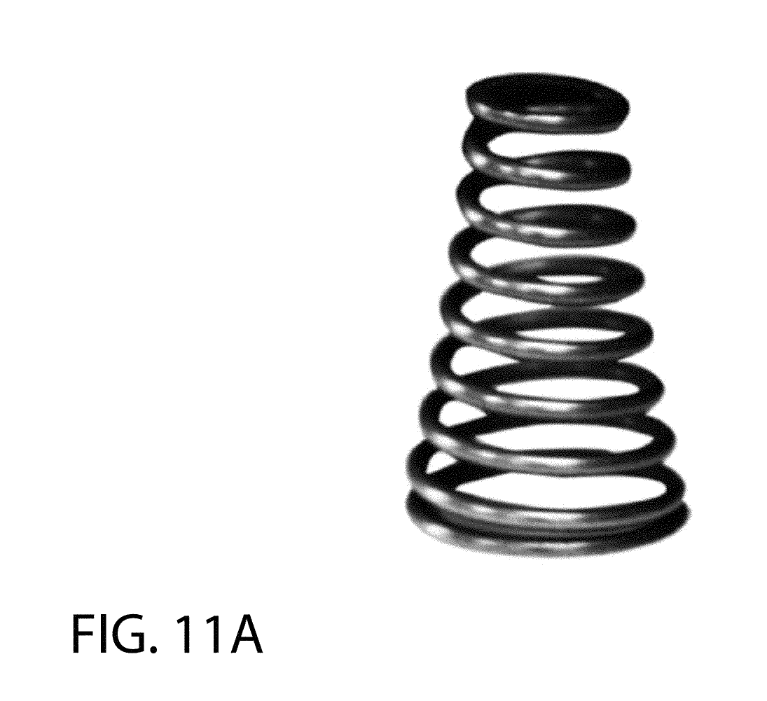

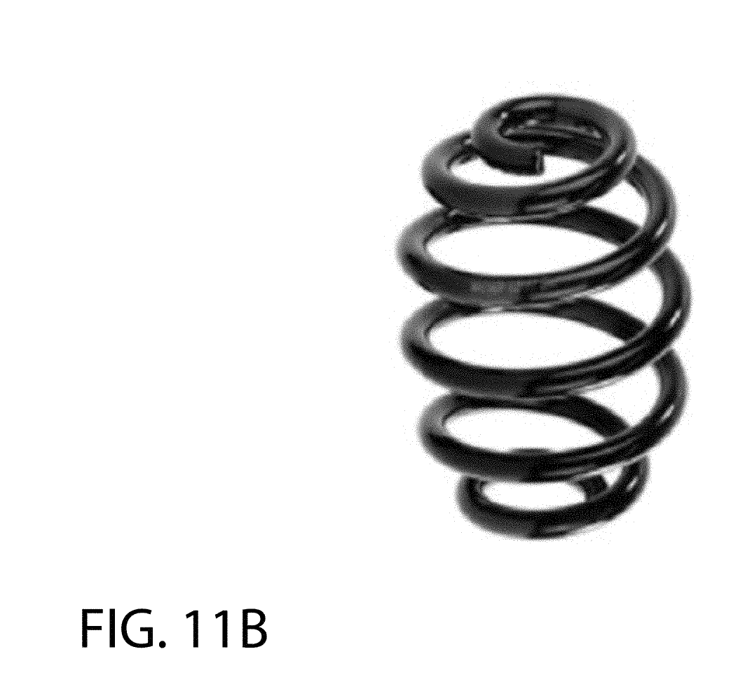

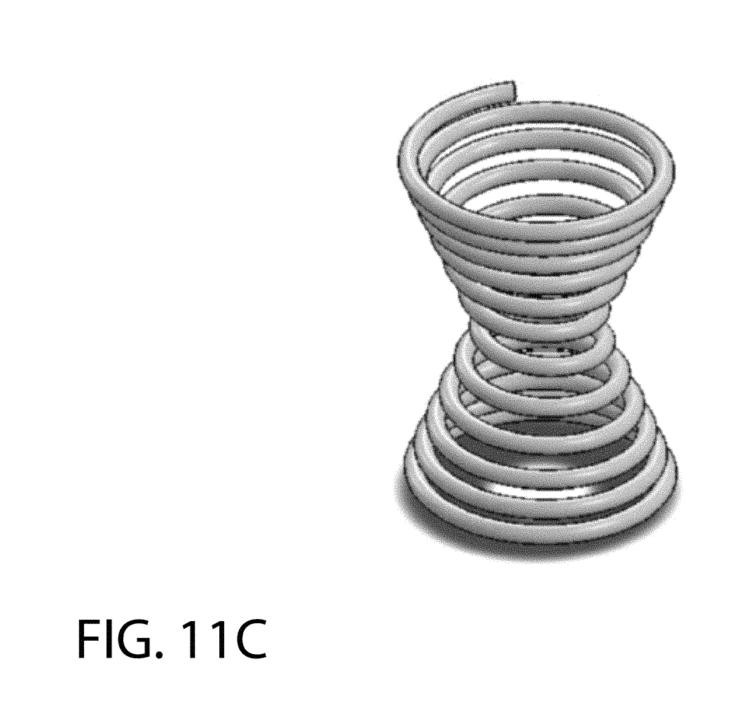

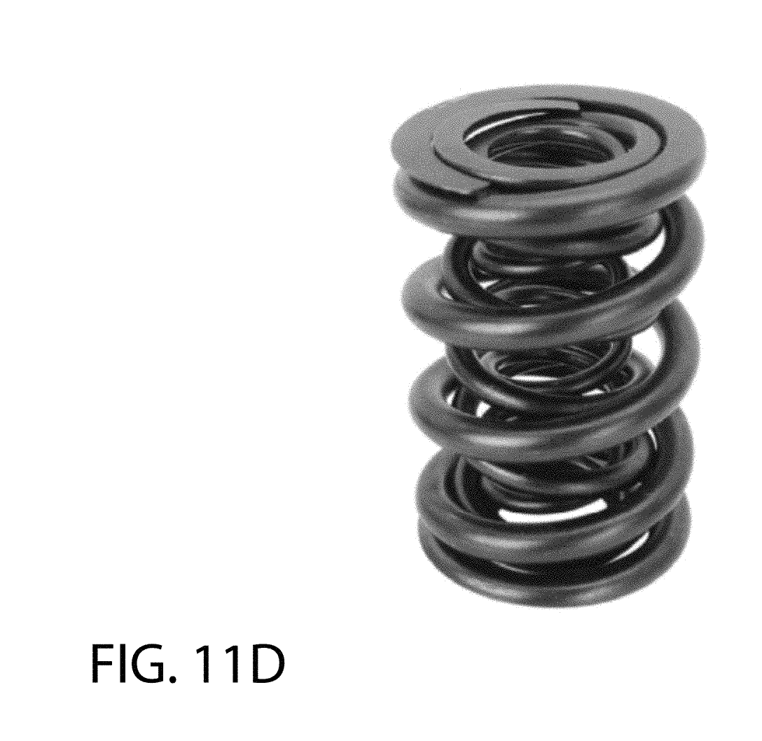

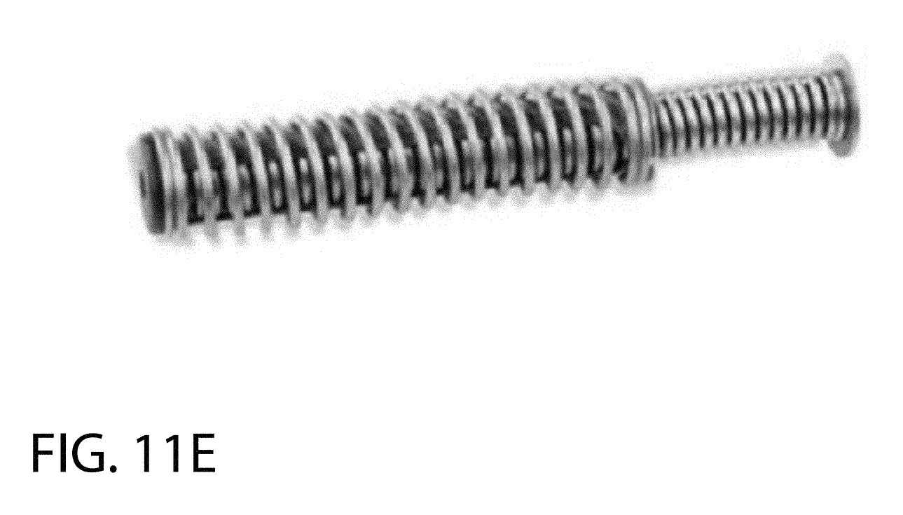

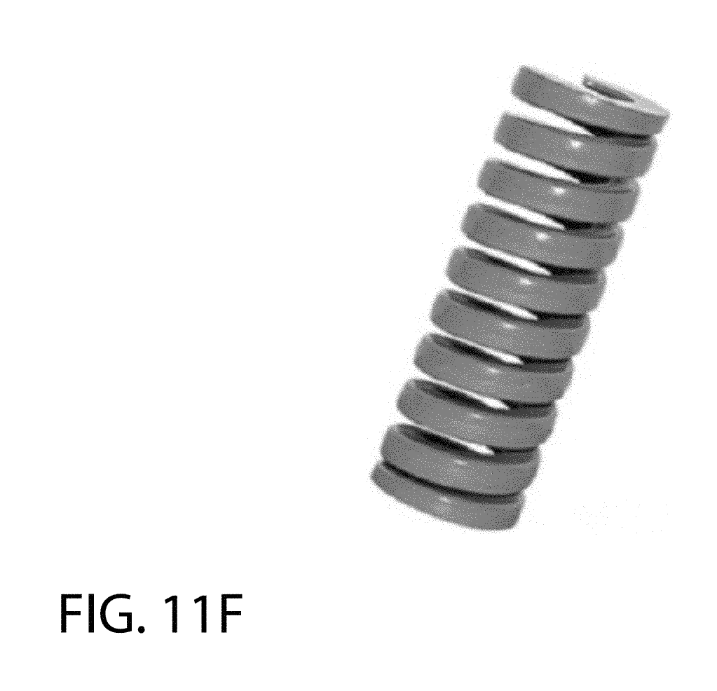

Additional permutations of helical spring types and/or profiles are also possible. These permutations include conical spring of FIG. 11A, barrel spring of FIG. 11B, hourglass spring of FIG. 11C, and variable pitch spring (not shown). FIGS. 11D and 11E illustrate examples of dual spring embodiments. FIG. 11F depicts a helical spring wound from a substantially polygonal wire stock, e.g., a rectangular wire.

While this invention has been described in terms of several embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A robotic tool buffering system for flexibly and securing suspending a finishing tool from a robotic arm while providing substantially constant compression pressure using use, the buffering system comprising:
a robotic arm interface configured to be attached to a robotic arm;
a finishing tool interface configured to be attached to a surface finishing tool; and
a plurality of compressible buffer assemblies coupled between the robotic arm interface and the tool interface, wherein the buffer assemblies are configured to provide substantially constant compression pressure between the finishing tool and a target surface, and further configured to provide a substantially level orientation of the finishing tool relative to the target surface, wherein each of the buffer assembly includes:
a coupler configured to be securely coupled to the the robotic arm interface while permitting the tool interface to travel along a radial axis of the coupler relative to the robotic arm interface;
at least one hollow compressible buffer having a free length and configured to be compressed to an assembled length and an in-use length; and
an axial travel stop configured to flexibly secure the tool interface to the robotic arm interface thereby preventing separation of the finishing tool from the robotic arm during use.

2. The robotic tool buffering system of claim 1 wherein the finishing tool is a sander or a polisher.

3. The robotic tool buffering system of claim 1 wherein the hollow compressible buffer is a helical spring.

4. The robotic tool buffering system of claim 1 wherein the coupler is a threaded bolt.

5. The robotic tool buffering system of claim 1 wherein the axial travel stop is a locknut.

6. The robotic tool buffering system of claim 1 wherein the coupler is attached to the robotic arm interface by welding or brazing.
